(19) United States
(12) Patent Application Publication
(10) Pub. No.: US 2025/0002407 A1
(43) Pub. Date: Jan. 2, 2025

(54) A CONCRETE FIBER ADDITIVE WITH PATTERNED SURFACE FOR CONCRETE REINFORCEMENT AND A CONCRETE COMPRISING SUCH FIBER

(71) Applicant: KORDSA TEKNIK TEKSTIL A.S., Kocaeli (TR)

(72) Inventors: Tugba OCAKOGLU, KOCAELI (TR); Tuluhan ERGIN, KOCAELI (TR); Ugur ALPARSLAN, KOCAELI (TR); Burak ERDAL, KOCAELI (TR)

(73) Assignee: KORDSA TEKNIK TEKSTIL A.S., Kocaeli (TR)

(21) Appl. No.: 18/698,794

(22) PCT Filed: Oct. 10, 2022
(86) PCT No.: PCT/TR2022/051109

§ 371 Date: Apr. 5, 2024

(30) Foreign Application Priority Data
Oct. 14, 2021 (TR) 2021/016067

(51) Int. Cl. C04B 16/06; C04B 20/00

(52) U.S. Cl. CPC C04B 16/06; C04B 20/0048

(57) ABSTRACT

A concrete fiber additive comprising a polymer fiber is provided. The polymer fiber is characterized by bumps arranged one after another on the surface and cavities formed inside the bumps or between the neighboring bumps.

### CROSS REFERENCE TO THE RELATED APPLICATIONS

This application is the national phase entry of International Application No. PCT/TR2022/051109, filed on Oct. 10, 2022, which is based upon and claims priority to Turkish Patent Application No. TR2021/016067, filed on Oct. 14, 2021, the entire contents of which are incorporated herein by reference.

### TECHNICAL FIELD

The present invention relates to a concrete fiber additive with patterned surface for concrete reinforcement and a concrete reinforcement with such fibers.

### BACKGROUND

Concrete building block, which is generally used in field of construction, comprises cement, water and aggregate components. In applications where the durability of the concrete is desired to be increased, for example ground concretes, coating concretes (screed, topping) and shotcrete, additives such as polymer fiber (2) can be added into the concrete in addition to the said components. Crack resistance and energy absorption capacity of the concrete reinforced with fiber increase. In addition, fiber reinforcement limits plastic and drying shrinkage occurring in concrete. Even though it is not applied very often, there are application examples where fiber reinforcement is used instead of steel reinforcements.

Concrete is a building block with high compressive strength but low resistance against tensile stresses. Therefore, it is used together with a steel reinforcement when it is used in the bearing elements of the structures. Thus, bearing elements are formed in a composite structure of concrete-steel reinforcement with high resistance to both compressive and tensile stress. In order for the said composite structure to yield high performance, the concrete and the reinforcement must be tightly bonded/interlocked together, and thereby working together. This situation is called bonding in the state of the art. In order to increase the bonding performance, there are surface structures called ribs provided on the steel reinforcement in the state of the art.

### SUMMARY

The present invention relates to increasing the concrete-fiber bonding performance in fiber reinforced concretes. By means of providing a fiber reinforced concrete with increased bonding performance, a building block with increased performance is obtained and a more cost-effective fiber reinforced concrete has been achieved by reducing the fiber content to be used in unit concrete in direct proportion to the increase in performance.

In order to facilitate better understanding of a concrete reinforcement fiber with patterned surface provided to fulfil the objective of the present invention, the application is shown in the accompanying figures, and the details of the invention should be evaluated by considering the entire description.

### BRIEF DESCRIPTION OF THE DRAWINGS

FIG. 1 is the schematic view of a concrete fiber additive comprising strip-shaped bumps in an embodiment of the invention.

FIG. 2 is the enlarged view of detail D1 in FIG. 1, showing the angle which the bumps make with one edge of the polymer fiber.

FIG. 3 is the schematic view of the elliptical dent.

FIG. 4 is the schematic view of a concrete fiber additive comprising strip-shaped bumps arranged almost parallel to one side of the polymer fiber in an embodiment of the invention.

FIG. 5 is the schematic view of a concrete fiber additive comprising hollow diamond shaped bumps in an embodiment of the invention.

FIG. 6 is the schematic view of detail D2 in FIG. 5, showing the smallest diamond-shaped rhombus in an embodiment of the invention.

FIG. 7 Tensile test result graph of concretes comprising sample concrete fiber additives.

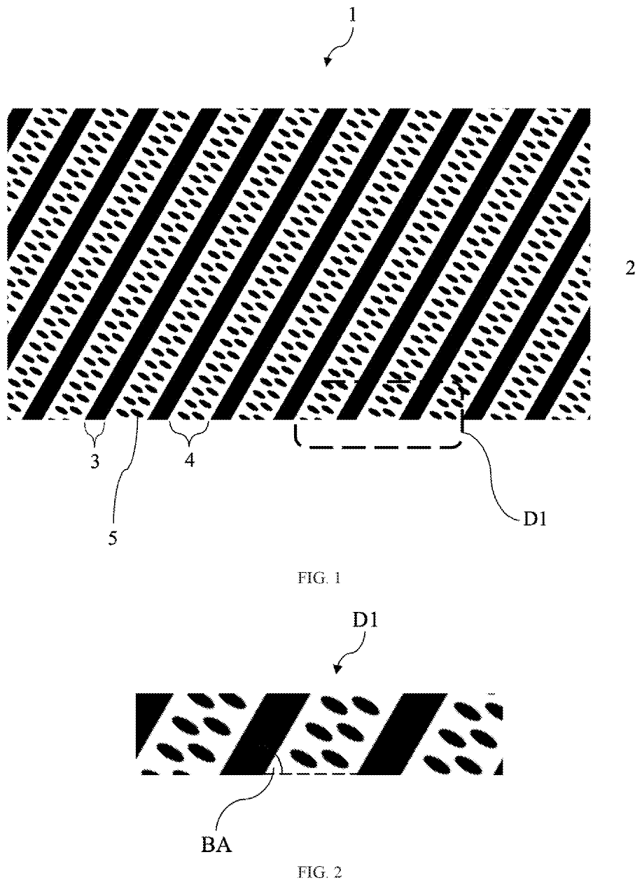

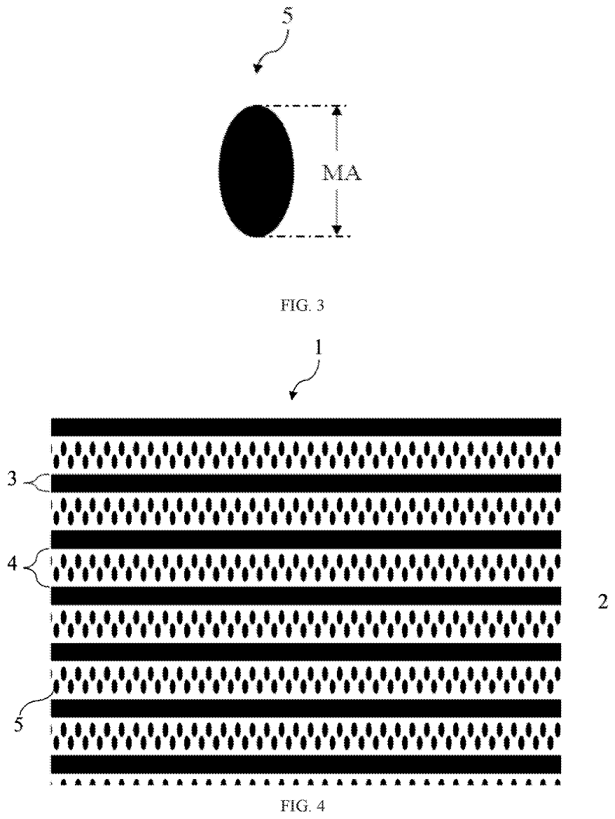

The elements shown in the figures are each given reference numbers as follows:
1. Concrete fiber additive
2. Polymer fiber
3. Bump
4. Cavity
5. Elliptical dent
MA. Major axis
SDL. Short diagonal length
LDL. Long diagonal length
BA. Bump angle
D1. Detail 1
D2. Detail 2

### DETAILED DESCRIPTION OF THE EMBODIMENTS

The invention of the present application relates to a concrete fiber additive (1) comprising a polymer fiber (2), bumps (3) arranged one after another on the surface of the polymer fiber (2), and cavities (4) formed inside the bumps (3) or between the neighboring bumps (3).

In an embodiment of the invention, the bumps (3) are in the form of a strip extending along the surface of the polymer fiber (2).

In an embodiment of the invention, the bumps (3) preferably have a height/depth of 10-600 microns. These bumps (3) preferably have a thickness of between 0.1 and 3 mm. The cavity (4) preferably has a width of 0.1-3 mm.

An embodiment of the invention comprises elliptical dents (5) extending in at least one row along at least one cavity (4) between the strip-shaped bumps (3). The ellipses preferably have a major axis (MA) of 0.1-2.9 mm.

One embodiment of the invention comprises 0.63 mm wide cavities (4), elliptical dents (5) with a major axis (MA) of 0.5 mm, strip-shaped bumps (3) with a thickness of 0.63 mm and arranged at an angle of approximately 60° to one edge of the polymer fiber (2).

One embodiment of the invention comprises 0.63 mm wide cavities (4), elliptical dents (5) with a major axis (MA) of 0.5 mm, strip-shaped bumps (3) with a thickness of 0.63 mm and arranged at an angle of approximately 75° to one edge of the polymer fiber (2).

One embodiment of the invention comprises 1.2 mm wide cavities (4), elliptical dents (5) with a major axis (MA) of 0.5 mm, strip-shaped bumps (3) with a thickness of 0.6 mm and arranged almost parallel to an edge of the polymer fiber (2).

An embodiment of the invention comprises bumps (3) in the form of a diamond pattern with a cavity (4) inside, extending along the surface of the polymer fiber (2). Here, the rhombus shapes which make up the diamond pattern are hollow. A variation of this embodiment comprises diamond-shaped bump (3), in which short diagonal length (SDL) of the smallest rhombus shape in diamond pattern is 0.83 mm and the long diagonal length (LDL) thereof is 1.3 mm.

In the preferred embodiment of the invention, the polymer fibers (2) are in a mono structure. However, the polymer fibers (2) can also be in the form of a bundle. In an embodiment of the invention adaptable to all embodiments thereof, the polymer fibers (2) are elongated, preferably in the form of a rectangle.

In an embodiment of the invention, the polymer fiber (2) may comprise at least one of polyethylene, polyethyleneterephthalate, polyamide 6,6 polypropylene or polyolefin fibers. Concrete fiber additive (1) applications can be performed with most polymer fibers (2). However, since the said fibers, especially the surface of the polyethylene fiber, can be shaped easily and more precisely, the concrete fiber additive (1) comprising the said fibers is easy to produce. For these reasons, it is preferred to use polymer fiber (2) comprising said fibers.

In an embodiment of the invention, the polymer fiber (2) has a length of 30-76 mm.

In an embodiment of the invention, the polymer fiber (2) has an equivalent diameter of 0.3-1.5 mm. Here, the equivalent diameter is the diameter of a circle with an area equal to the average cross-sectional area of the fiber, and if the fiber is in cylindrical form, the equivalent diameter is equal to the diameter of the fiber. It has been observed that the interlocking of the polymer fiber (2) with the specified range length and equivalent diameter to the concrete is high.

In an embodiment of the invention, the polymer fiber (2) has a thickness of 50-1500 tex.

In one embodiment of the invention, the polymer fiber (2) has a tensile stress of 300-1500 MPa.

In one embodiment of the invention, the polymer fiber (2) has an elasticity modulus of 3-20 GPa.

An embodiment of the invention is a concrete comprising the concrete fiber additive (1).

In this embodiment, the concrete fiber additive (1) is preferably provided in the concrete at a ratio of 0.1-2% by volume. It has been observed that the ratios in this range can provide the desired durability in the concrete structure.

The concrete fiber additive (1) provided in the embodiments of the invention can interlock to the concrete by the bumps (3), cavities (4) and dents (5) on surfaces thereof. Thus, the efficiency of the fiber additive in the concrete and thus the load bearing capacity of the concrete increases. The toughness [total energy absorbed by the material until breakage] of the concrete reinforced with concrete fiber additive (1) has been increased. The residual shear strength [residual strength] of concrete is increased. With the increase of the concrete-fiber bonding performance, the crack resistance of the concrete has been increased and the shrinkage stresses have been limited.

While the invention was being developed, concrete fiber additive (1) in multiple different forms was obtained. Samples reinforced with these concrete fiber additives (1) were created. These samples were subjected to a third-point Flexural Tensile Test together with a reference. “ASTM C 1609 Standard Test Method for Flexural Performance of Fiber-Reinforced Concrete” (Using Beam With Third-Point Loading) standard was used for the test.

The used concretes to be reinforced with the fiber comprise cement, water and aggregate.

The reference sample is a fiber reinforced concrete comprising a fiber with a smooth surface (no bumps, cavities and dents).

Concrete fiber additives (1) are dispersed (random distribution) in the concrete. The polymer fibers (2) contained in the fiber reinforced concrete samples are as follows:

The polymer fiber (2) contained in the concrete sample in Sample 1 has strip-shaped bumps (3) arranged one after another. The bumps (3) are positioned at an angle of approximately 60° [bump angle (BA)=600] with one edge of the polymer fiber (2). The bumps (3) have a width of 0.63 mm and a height of 200 microns. The width of the cavities (4) formed between the subsequent bumps (3) is 0.63 mm. There are elliptical dents (5) between each two bumps (3). The dents (5) are in two successive rows and they are positioned so that one overlaps the other. The major axis (MA) of the ellipses is 0.5 mm. FIG. 1 schematically shows the polymer fiber (2) in sample 1 without scale.

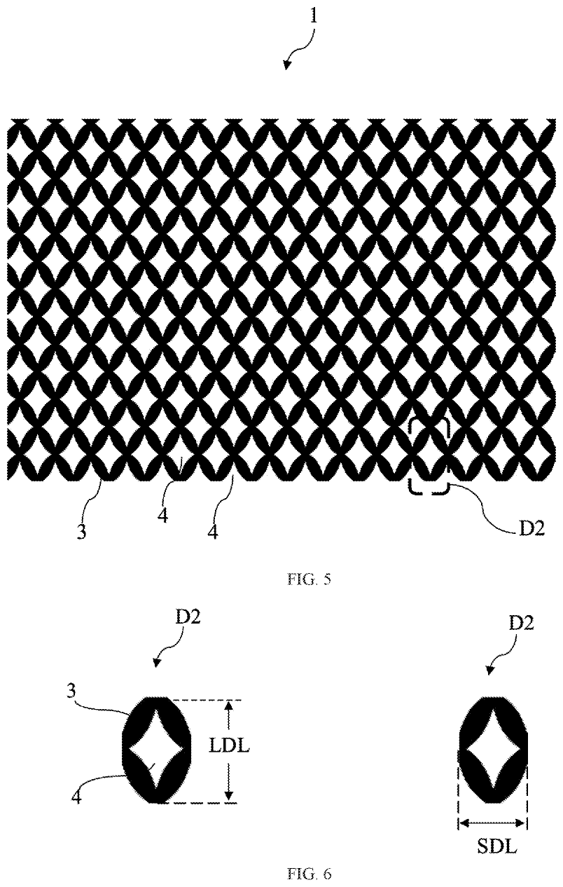

Briefly, Sample 2 is the polymer fiber (2) in sample 1, with a bump angle (BA)=0°. The polymer fiber (2) contained in Sample 2 has strip-shaped bumps (3) arranged one after another. The bumps (3) are positioned at an angle of approximately 0° [bump angle (BA)=0° ] with one edge of the polymer fiber (2), in other words they are positioned in parallel. The bumps (3) have a thickness of 0.6 mm and a height of 200 microns. The width of the cavities (4) formed between the subsequent bumps (3) is 1.2 mm. There are elliptical dents (5) between each two bumps (3). The dents (5) are in two successive rows and they are positioned so that one overlaps the other. The major axis (MA) of the ellipses is 0.5 mm. FIG. 4 schematically shows the polymer fiber (2) in sample 2 without scale.

The polymer fiber (2) contained in Sample 3 has bumps (3) in the form of a hollow diamond extending along the surface of the polymer fiber (2). The short diagonal length (SDL) of the smallest rhombus shape in the diamond pattern is 0.83 mm, and the long diagonal length (LDL) is 1.3 mm. The bumps (3) have a thickness of 0.25 mm and a height of 200 microns. FIG. 5 schematically shows the polymer fiber (2) in sample 3 without scale.

Briefly, Sample 4 is the polymer fiber (2) in sample 1, with a bump angle (BA)=75°. The polymer fiber (2) contained in Sample 4 has strip-shaped bumps (3) arranged one after another. The bumps (3) are positioned at an angle of approximately 750 [bump angle (BA)=75° ] with one edge of the polymer fiber (2). The bumps (3) have a thickness of 0.63 mm and a height of 200 microns. The width of the cavities (4) formed between the subsequent bumps (3) is 0.63 mm. There are elliptical dents (5) between each two bumps (3). The dents (5) are in two successive rows and they are positioned so that one overlaps the other. The major axis (MA) of the ellipses is 0.5 mm. FIG. 1 schematically shows the polymer fiber (2) in sample 1 without scale.

The test results are as in the table below

| | Toughness |
|---|---|
| Sample | (Joule) |
| Reference | 26 |
| Sample 1 | 37.68 |
| Sample 2 | 51 |
| Sample 3 | 50 |
| Sample 4 | 40.535 |

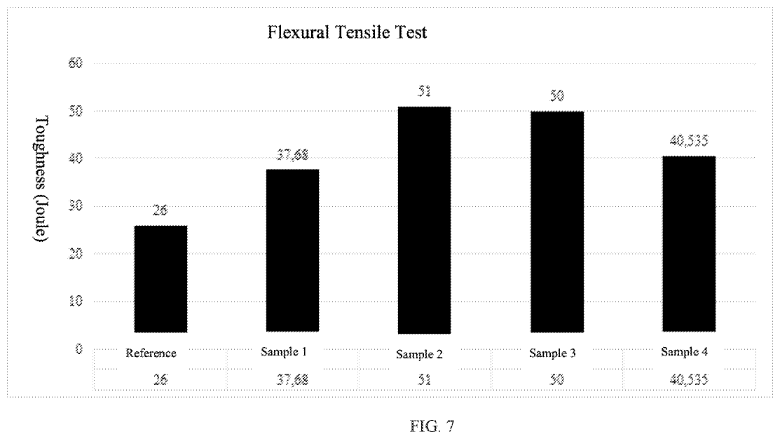

The test results are also shown as a graph in FIG. 7.

What is claimed is:

1. A concrete fiber additive comprising a polymer fiber comprising: bumps arranged one after another on the surface of the polymer fiber, and cavities, wherein the cavities are formed inside the bumps or between the neighboring bumps.

2. A concrete fiber additive according to claim 1, comprising bumps in the form of a strip extending along the surface of the polymer fiber.

3. A concrete fiber additive according to claim 1, comprising a bump with a height of 10-600 microns and a thickness of 0.1-3 mm, and a cavity with a width of 0.1-3 mm.

4. (canceled)

5. (canceled)

6. A concrete fiber additive according to claim 1, comprising elliptical dents extending in at least one row along at least one cavity between the strip-shaped bumps.

7. A concrete fiber additive according to claim 6, wherein the elliptical dent have a major axis (MA) of 0.1-2.9 mm.

8. A concrete fiber additive according to claim 7, comprising 0.63 mm wide cavities, elliptical dents with a major axis (MA) of 0.5 mm, and strip-shaped bumps with a thickness of 0.63 mm and arranged at an angle of approximately 60° to one edge of the polymer fiber.

9. A concrete fiber additive according to claim 7, comprising 0.63 mm wide cavities, elliptical dents with a major axis (MA) of 0.5 mm, and strip-shaped bumps with a thickness of 0.63 mm and arranged at an angle of approximately 75° to one edge of the polymer fiber.

10. A concrete fiber additive according to claim 7, comprising 1.2 mm wide cavities, elliptical dents with a major axis (MA) of 0.5 mm, and strip-shaped bumps with a thickness of 0.6 mm and arranged almost parallel to an edge of the polymer fiber.

11. A concrete fiber additive according to claim 1, comprising bumps in the form of a diamond pattern with a cavity inside, extending along the surface of the polymer fiber.

12. A concrete fiber additive according to claim 11, wherein the bumps in the form of a diamond pattern have a short diagonal length (SDL) of the smallest rhombus shape in diamond pattern of 0.83 mm and a long diagonal length (LDL) of 1.3 mm.

13. A concrete fiber additive according too claim 1, wherein the polymer fiber has a mono structure.

14. A concrete fiber additive according to claim 1, wherein the polymer fiber is in the form of a bundle.

15. A concrete fiber additive according to claim 1, wherein the polymer fiber is at least one selected from the group consisting of polyethylene, polyethyleneterephthalate, polyamide 6,6 polypropylene and polyolefin fibers.

16. A concrete fiber additive according to claim 1, wherein the polymer fiber has a length of 30-76 mm.

17. A concrete fiber additive according to claim 1, wherein the polymer fiber has an equivalent diameter of 0.3-1.5 mm.

18. A concrete fiber additive according to claim 1, wherein the polymer fiber has a thickness of 50-1000 tex.

19. A concrete fiber additive according to claim 1, wherein the polymer fiber has a tensile stress of 300-1500 MPa.

20. A concrete fiber additive according to claim 1, wherein the polymer fiber has an elasticity modulus of 3-20 GPa.

21. A concrete comprising the concrete fiber additive according to claim 1.

22. A concrete according to claim 21, wherein the concrete fiber additive is 0.1-2% by volume.
